(19) United States
(12) Patent Application Publication
(10) Pub. No.: US 2010/0310102 A1
(43) Pub. Date: Dec. 9, 2010

(54) Method for the individual optimization & customization of hearing aids & hearing devices

(76) Inventor: Carlton James Melone, II, Ridgewood, NJ (US)

Correspondence Address: Carlton J. Melone 2nd;(AKA Carl W. Melone), 134 Foster Terrace, Ridgewood, NJ, 07450, US

(21) Appl. No.: 12/583,372

(22) Filed: Aug. 20, 2009

Related U.S. Application Data
(60) Provisional application No. 61/268,371, filed on Jun. 8, 2009.

(51) Int. Cl. H04R 25/00

(52) U.S. Cl. 381/314

(57) ABSTRACT

The current patent describes the methodology for customizing the overall hearing performance of traditional Hearing Aids for individuals. This application details the means of using currently available technology to customize the performance for the individual hearing deficiency. The application further describes a method to enhance the audio frequency reception by assigning individual “amplification-factors” to discrete frequency tones in the overall Audible Frequency spectrum. The Method emphasizes the importance of providing correction to discrete frequency components as opposed to applying corrections across “frequency bands” in the Audible Frequency spectrum.

### CROSS REFERENCE TO RELATED APPLICATIONS

A provisional application has been submitted in relation to this application (61/268,371 dated Jun. 8, 2009).

### FEDERALLY SPONSORED RESEARCH OR DEVELOPMENT

There is no Federally Sponsored Research or Development associated with this application.

### REFER TO SEQUENCE LISTING, TABLE OR COMPUTER LISTING

There are no submittals of this nature with this application.

### BACKGROUND OF INVENTION

Current Hearing Aids employ a broad base amplification scheme across the audible spectrum in an attempt to provide hearing improvement for the general population. Hearing deficiencies are related to losses in the frequency spectrum that are unique to each individual's audio detection characteristics across the audible frequency spectrum. The current simplified amplification correction factor provided by current Hearing Aid technology does not provide compensation for individual deficiencies, but rather provides a sweeping amplification across broad frequency bands, in the process distorting the relative frequency components of the spoken word in those frequency bands. The optimization and customization of individual hearing deficiencies, across the audible frequency spectrum, is critical to not only sound recognition but also to the clarity of word recognition of the audible sound received. The ability to provide discrete frequency corrections is the crucial component of improving overall hearing for each individual.

### BRIEF SUMMARY OF INVENTION

The proposed invention describes the use of a programmable Hearing Aid, controlled by either direct or wireless communication, and a tone generator, provided in a audio lab or by a PC instrumented with a frequency synthesizer and headsets, that would allow the individual to customize his/her audio compensation factors by setting the amplification factors for discrete frequencies, not bands, across the audible frequency spectrum.

### DESCRIPTION OF VIEWS

There are three figures submitted with this application:

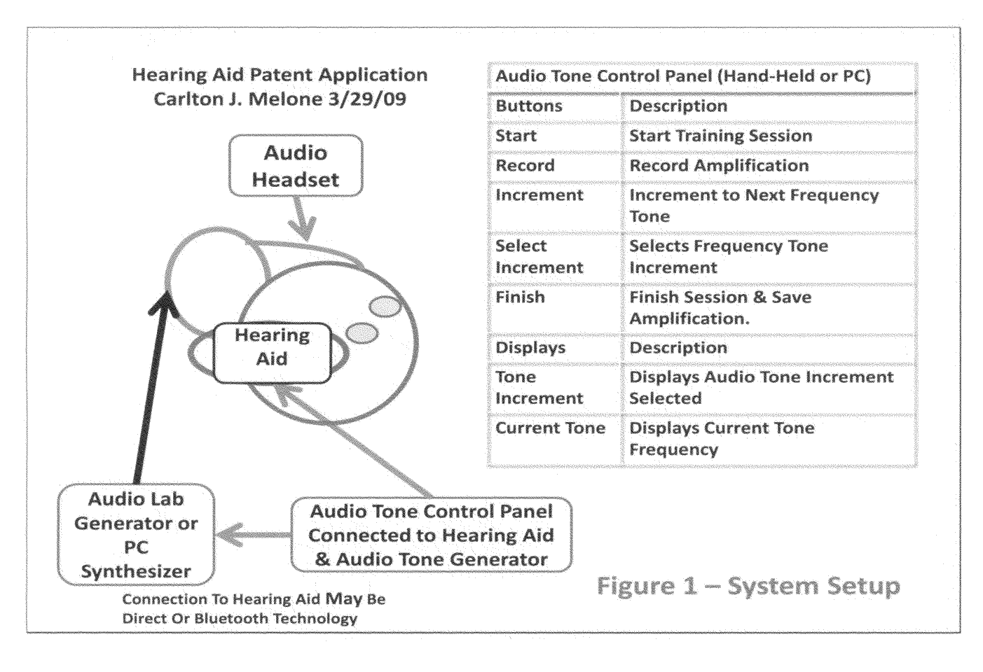

FIG. 1: Schematic representation of Individual, HeadSet, Tone Generator and Audio Control Panel (audio lab equipment or personal PC).

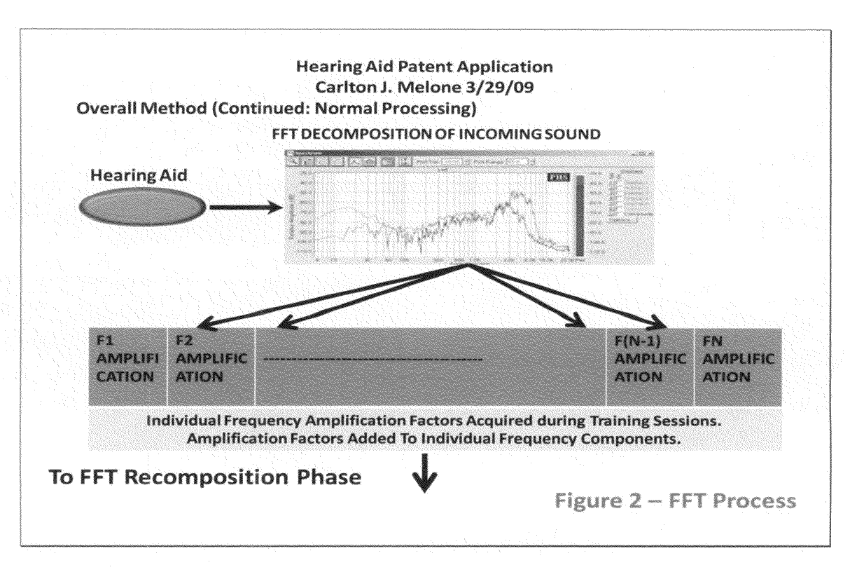

FIG. 2: FFT of Incoming Audio.

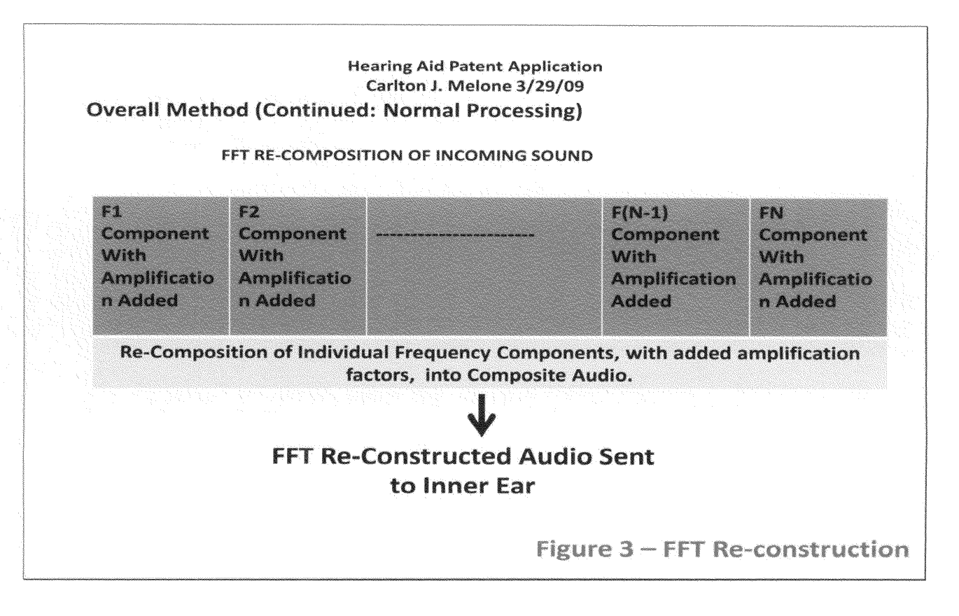

FIG. 3: FFT Re-Composition of Incoming Sound.

### DESCRIPTION OF INVENTION

The current invention (refer to FIG. 1) employs a programmable Hearing Aid adapted for communications, direct or wireless, with a Hand-Held device or PC instrumented with a Frequency Synthesizer or coupled to a Audio-Lab Tone Generator and attached to a Audio Headset used by the individual. Communications between the Hand-Held device or PC may be through direct wired connection or via wireless technology such as Bluetooth.

The PC Frequency Synthesizer or Audio-Lab Tone Generator are high fidelity Audio sources, capable of delivering Discrete Audio Frequency Tones across the entire Audible Frequency range with defined frequency resolution. The frequency resolution can be defined as low as 0.01 Hz or better.

The HeadSet carries the high fidelity audio frequency tones to the individual wearing the Hearing Aid.

The Hearing Aid incorporates functionality for communicating with the Hand-Held device or PC as well as the following:
1. Audio Receive Processing—This is standard with the current Hearing Aid Technology. The current invention does not require individual sensors, within the hearing aid, for detecting the discrete audio tones generated since the Hearing Aid will be sequenced through the discrete frequencies by the Hand-Held device or PC. The sequencing of frequencies is under the control of the individual. When the individual is able to hear the tone, the Hearing Aid will receive a “Record Amplification” from the Hand-Held device or PC.
2. FFT (Fast Fourier Transform)—Existing Technology used to separate the Received Audio into its discrete Frequency Components. The stored amplification factors, recorded during the training or customization session by the individual, will then be applied to the individual frequency tones as audio reconstruction is performed.
3. FFT Reconstruction—After the individual amplification factors are applied to the discrete frequency components generated by the FFT, frequency reconstruction is performed and the composite audio is applied to the inner ear.

The basic method embodied in the current invention employs all the components described above in the following manner:

A. The individual inserts the Hearing Aid and then places the Headset, which has been connected to the Audio Tone Generator or the PC Synthesizer, over both ears and enclosing the Hearing Aid(s).
B. The individual utilizes the Hand-Held device or uses the PC to establish the starting frequency and the frequency resolution at which the “training” or “customization” session is to occur. The individual then initiates the session by hitting the “Start” button on the Hand-Held device or PC. If the individual requires Hearing Aids in both ears, the program running in the Hand-Held device will put up two interactive panels for the individual to manipulate each Hearing Aid independently. Each session can be as long as the individual desires, improving amplification factors for isolated sections of the audible frequency spectrum. Initially the individual will start with a broad base amplification profile which can then be modified according to the individual deficiencies.
C. Once the Training or Customization session starts, the Hearing Aid(s) start to accumulate “amplification-factors” for the discrete Audio Tones generated by the equipment. The amplification-factors are stored in non-volatile storage locations within the Hearing Aid(s).
D. The individual may choose to work with all, or any portion, of the Audible Frequency Range during a Training Session. The individual has the option of selecting the Frequency Resolution for each session. Depending on the Frequency Resolution selected the individual will have the option of selecting a smoothing function for intermediate frequencies. The training or customization session is terminated when the individual selects the “EXIT” function on the Hand-Held device or PC.
E. During normal operation the Hearing Aid processes Audible sound by passing the incoming sound through an FFT function, then applying the amplification-factors to the discrete frequency components and finally reconstructing the corrected discrete frequency components and applying the composite audio sound to the inner ear.

1. The current invention provides a Method for customizing a programmable hearing aid(s), either in the current available Audio Lab environments or within the confines of the individuals domicile, to compensate for the individual's hearing loss at discrete frequencies within, or surrounding, the audible frequency range.

2. The system of claim 1 consists of a programmable Hearing Aid (with DSP, memory and supporting analog audio circuitry), a Hand-Held device or PC (running custom application software for providing interaction with the individual and controlling the programming of the Hearing Aid(s)) and the Audio Tone Generator (either part of the Audio Lab Equipment or implemented with a Synthesizer capability within the PC).

3. The system of claim 2 may be connected directly or by wireless communication to the Hearing Aid and other supporting equipment.

4. The system of claim 1 may be used for customizing two Hearing Aids at the same time or in separate sessions if the individual has hearing loss in both ears.

5. The system of claim 1 provides the individual the ability to correct for deficiencies at discrete frequency components within the audible frequency range and is not limited to frequency corrections across a band of frequencies. The Method provides for the selection of frequency resolution depending on the individual's needs.

6. The system of claim 1 provides the individual the ability to progressively optimize the compensation for the individual's unique hearing loss over the course of time for slight changes in the individual's hearing deficiencies or for obtaining the optimum results for the individual's current hearing deficiencies.
